(19) United States
(12) Patent Application Publication
(10) Pub. No.: US 2024/0143695 A1
(43) Pub. Date: May 2, 2024

(54) SPARSE MATRIX VECTOR PRODUCT OPERATION DEVICE, SPARSE MATRIX VECTOR PRODUCT OPERATION METHOD, AND SPARSE MATRIX VECTOR PRODUCT OPERATION PROGRAM

(71) Applicant: NEC Corporation, Tokyo (JP)

(72) Inventor: Takuya ARAKI, Tokyo (JP)

(73) Assignee: NEC Corporation, Tokyo (JP)

(21) Appl. No.: 18/380,090

(22) Filed: Oct. 13, 2023

(30) Foreign Application Priority Data
Oct. 31, 2022 (JP) 2022-174178

(51) Int. Cl. G06F 17/16

(52) U.S. Cl. CPC G06F 17/16

(57) ABSTRACT

A sparse matrix vector product operation device 20 includes a generating unit 21 which generates a second sparse matrix of a predetermined form by arranging a plurality of columns having a predetermined number or more non-zero components among a plurality of columns constituting a first sparse matrix of the predetermined form in order of the number of non-zero components.

This application is based upon and claims the benefit of priority from Japanese patent application No. 2022-174178, filed on Oct. 31, 2022, the disclosure of which is incorporated here in its entirety by reference.

### BACKGROUND

### Technical Field

The present invention relates to a sparse matrix vector product operation device, a sparse matrix vector product operation method, and a sparse matrix vector product operation program.

### Related Art

In the fields of machine learning and high-performance computing (HPC), matrix operations are often used. In matrix operations, “a sparse matrix”, that is a matrix in which only some components have non-zero values (hereinafter referred to as “non-zero components”), while other components are all zero (hereinafter referred to as “zero components”), is often used. When only the non-zero components are stored using the properties of the sparse matrix, it saves storage space and reduces computation time.

FIG. 16 is an explanatory diagram showing an example of a sparse matrix. The white rectangle in the sparse matrix shown in FIG. 16 represents the zero component. The shaded rectangle in the sparse matrix shown in FIG. 16 represents the non-zero component (the same applies to the other figures).

As shown in the left of FIG. 16, a sparse matrix is a matrix in which only some components have non-zero values. As shown in the right of FIG. 16, the sparse matrix is efficiently stored by packing and storing only the non-zero components.

The operation on a sparse matrix is often the operation to obtain the product of a sparse matrix and a vector (hereafter referred to as “the sparse matrix vector product”). FIG. 17 is an explanatory diagram showing an example of an operation on a sparse matrix.

As shown in FIG. 17, the sparse matrix vector product is obtained by multiplying the sparse matrix with the column vector. Note that the operation on the sparse matrix is performed on a sparse matrix of the form packed with non-zero components, for example.

An example of a sparse matrix form with packed non-zero components is Jagged Diagonal Storage (JDS), which is a form often used in vector computers. A vector computer is a computer that performs operations at high speed by processing each “vector” unit.

To speed up processing by a vector computer, it is necessary to increase the vector length, which indicates the amount of data that can be processed by the vector computer at one time. JDS is often used in vector computers because JDS is a form can increase the vector length in operations which obtain the sparse matrix vector products.

FIG. 18 is an explanatory diagram showing an example of a JDS sparse matrix. As shown in the upper of FIG. 18, first all the non-zero components of the sparse matrix are packed to the left, and the sparse matrix is transformed into the matrix shown in the middle of FIG. 18.

Next, each row of the transformed matrix is sorted in order of the number of non-zero components and transformed to the matrix shown in the lower of FIG. 18. Next, the values of the non-zero components are stored in the column direction (vertical direction) of the transformed matrix.

FIG. 19 is an explanatory diagram showing an example of an internal representation of JDS. The internal representation of JDS shown in FIG. 19 corresponds to the JDS sparse matrix shown in FIG. 18. The memory that stores the JDS sparse matrix stores the “value (value),” “column position (index),” and “position where a new column starts (offset)” shown in FIG. 19, respectively.

The “value (value)” shown in FIG. 19 contains the values of the non-zero components in the column direction of the transformed matrix. The “column position (index)” shown in FIG. 19 contains the column positions of the original sparse matrix that contained the values of the non-zero components, respectively. The first column of the original sparse matrix is the zeroth column.

The “position where a new column starts (offset)” shown in FIG. 19 contains the orders of the components at which a new column starts in the matrix shown at the lower of FIG. 18, with the first “4” as the 0-th component, respectively. For example, the offset shown in FIG. 19 indicates that the next column starts from “5” as the 4-th component, “6” as the 8-th component, and “7” as the 11-th component, respectively. The offset shown in FIG. 19 also contains the end point (12).

FIG. 20 is an explanatory diagram showing another example of an operation on a sparse matrix. In the multiplication of a sparse matrix with a column vector shown in FIG. 20, the computations are performed as shown on the right side. In other words, only the computations for the non-zero components needs to be performed to obtain the sparse matrix vector product, since the computations for the zero components are useless computations.

FIG. 21 is an explanatory diagram showing another example of an operation on a sparse matrix. FIG. 21 shows the multiplication of a JDS sparse matrix with a column vector. In the example shown in FIG. 21, the multiplication with the column vector is performed column by column. Each time the multiplication is performed, the computation results are sequentially added to each component of the product vector, thereby realizing the operation on the sparse matrix. The order of the computation results is adjusted later when adding to each component.

The process of performing multiplication with the column vector for each column and sequentially adding the computation results to each component of the vector can be performed in parallel for the number of rows of the JDS sparse matrix (“4” in the example shown in FIG. 21), as shown in FIG. 21. In other words, when a JDS sparse matrix is used in an operation on a sparse matrix, the vector length becomes longer.

FIG. 22 is an explanatory diagram showing another example of an operation on a sparse matrix. In FIG. 22, multiplication of a JDS sparse matrix with a column vector is represented using the internal representation of JDS.

For example, as the parentheses shown in FIG. 22, since we know the break of each column from OFFSET, we can determine that the values of the first multiplication target are “4”, “1”, “8”, and “11”. In addition, since components of the access target (the multiplication target) can be determined among the components of the multiplying vector from the index, each value of value is multiplied by the value of each component of the access target. Next, the computation results are added to each component of the product vector. After the above process is repeated for each column, the sparse matrix vector product is obtained.

In addition, International Publication No. WO 2017/154946 describes an information processing method that enables high-speed computation on a vector computer of matrix vector products for a sparse matrix that stores data according to Power Low.

In addition, Japanese Patent Application Laid-Open No. 2019-175040 describes an information processing device that can maintain regularity in the matrix storage format for sparse matrices.

In addition, International Publication No. WO 2021/024300 describes an information processing device that transforms a sparse matrix, in which rows and columns with a large number of non-zero components are part of the matrix, into a form that allows high-speed computation of the product of the matrix and the vector.

### SUMMARY

Therefore, it is an object of the present invention to provide a sparse matrix vector product operation device, a sparse matrix vector product operation method, and a sparse matrix vector product operation program that can improve the performance of operations to obtain sparse matrix vector products.

A sparse matrix vector product operation device according to the present invention is a sparse matrix vector product operation device includes a generating unit which generates a second sparse matrix of a predetermined form by arranging a plurality of columns having a predetermined number or more non-zero components among a plurality of columns constituting a first sparse matrix of the predetermined form in order of the number of non-zero components.

A sparse matrix vector product operation device according to the present invention is a sparse matrix vector product operation device includes an addition unit which performs an addition process of searching in a row direction for a non-zero component of a row constituting a work matrix, which is composed of a plurality of columns having less than a predetermined number of non-zero components among a plurality of columns constituting a first sparse matrix of a predetermined form, and when the non-zero component is searched, extracting a column with the non-zero component constituting the work matrix from the work matrix, and adding the k-th (k is a positive integer) extracted column to a second sparse matrix of the predetermined form as the k-th column, for each row constituting the work matrix, in order from top repeatedly.

A sparse matrix vector product operation method according to the present invention is a sparse matrix vector product operation method includes generating a second sparse matrix of a predetermined form by arranging a plurality of columns having a predetermined number or more non-zero components among a plurality of columns constituting a first sparse matrix of the predetermined form in order of the number of non-zero components.

A sparse matrix vector product operation method according to the present invention is a sparse matrix vector product operation method includes performing an addition process of searching in a row direction for a non-zero component of a row constituting a work matrix, which is composed of a plurality of columns having less than a predetermined number of non-zero components among a plurality of columns constituting a first sparse matrix of a predetermined form, and when the non-zero component is searched, extracting a column with the non-zero component constituting the work matrix from the work matrix, and adding the k-th extracted column to a second sparse matrix of the predetermined form as the k-th column, for each row constituting the work matrix, in order from top repeatedly.

A sparse matrix vector product operation program according to the present invention, causing a computer to execute a generation process of generating a second sparse matrix of a predetermined form by arranging a plurality of columns having a predetermined number or more non-zero components among a plurality of columns constituting a first sparse matrix of the predetermined form in order of the number of non-zero components.

A sparse matrix vector product operation program according to the present invention, causing a computer to execute an addition process of searching in a row direction for a non-zero component of a row constituting a work matrix, which is composed of a plurality of columns having less than a predetermined number of non-zero components among a plurality of columns constituting a first sparse matrix of a predetermined form, and when the non-zero component is searched, extracting a column with the non-zero component constituting the work matrix from the work matrix, and adding the k-th extracted column to a second sparse matrix of the predetermined form as the k-th column, for each row constituting the work matrix, in order from top repeatedly.

### BRIEF DESCRIPTION OF DRAWINGS

FIG. 1 is a block diagram showing an example of the configuration of a sparse matrix vector product operation device of the example embodiment of the present invention;

FIG. 2 is a block diagram showing an example of the configuration of a column rearrangement unit 110;

FIG. 3 is an explanatory diagram showing an example of a rearrangement (reposition) of each column that constitutes an input matrix by a column sorting unit 112;

FIG. 4 is an explanatory diagram showing an example of a JDS sparse matrix in this example embodiment;

FIG. 5 is an explanatory diagram showing an example of an internal representation of JDS in this example embodiment;

FIG. 6 is a schematic diagram showing a JDS sparse matrix in this example embodiment;

FIG. 7 is an explanatory diagram showing an example of a column with a small number of non-zero components that constitutes a sparse matrix;

FIG. 8 is an explanatory diagram showing an example of a rearrangement of each column that constitutes an input matrix by an Index continuation unit 113;

FIG. 9 is an explanatory diagram showing an example of another rearrangement of each column that constitutes an input matrix by an Index continuation unit 113;

FIG. 10 is an explanatory diagram showing another example of a JDS sparse matrix in this example embodiment;

FIG. 11 is an explanatory diagram showing another example of an internal representation of JDS in this example embodiment;

FIG. 12 is a flowchart showing the operation of the sparse matrix vector product operation processing by the sparse matrix vector product operation device 100 of this example embodiment;

FIG. 13 is an explanatory diagram showing an example of a hardware configuration of the sparse matrix vector product operation device 100 according to the present invention;

FIG. 14 is a block diagram showing an overview of a sparse matrix vector product operation device according to the present invention;

FIG. 15 is a block diagram showing another overview of a sparse matrix vector product operation device according to the present invention;

FIG. 16 is an explanatory diagram showing an example of a sparse matrix;

FIG. 17 is an explanatory diagram showing an example of an operation on a sparse matrix;

FIG. 18 is an explanatory diagram showing an example of a JDS sparse matrix;

FIG. 19 is an explanatory diagram showing an example of an internal representation of JDS;

FIG. 20 is an explanatory diagram showing another example of an operation on a sparse matrix;

FIG. 21 is an explanatory diagram showing another example of an operation on a sparse matrix;

FIG. 22 is an explanatory diagram showing another example of an operation on a sparse matrix; and

FIG. 23 is a schematic diagram showing a JDS sparse matrix.

### DETAILED DESCRIPTION

[Description of Configuration]

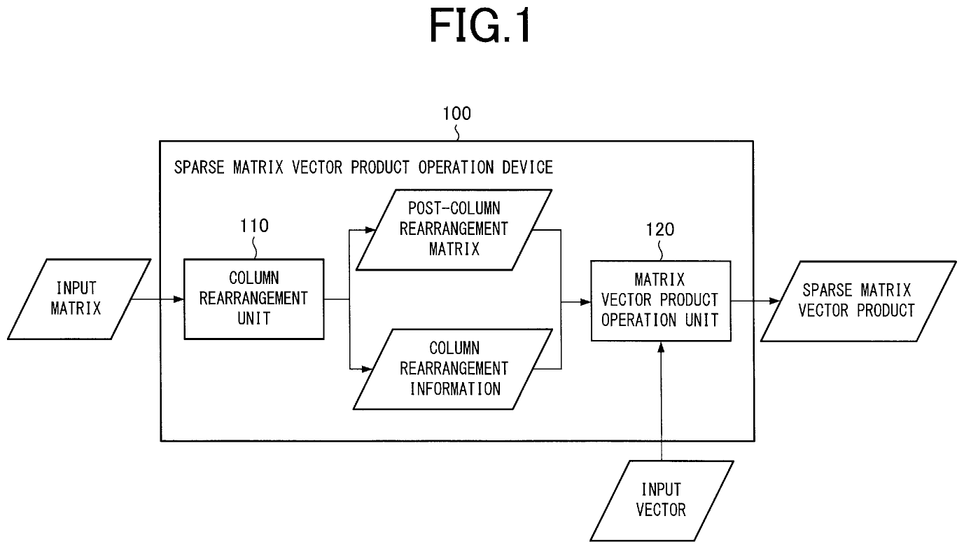

Hereinafter, an example embodiment of the present invention will be described with reference to the drawings. FIG. 1 is a block diagram showing an example of the configuration of a sparse matrix vector product operation device of the example embodiment of the present invention.

The sparse matrix vector product operation device 100 of this example embodiment is a device that improves the performance of operations to obtain sparse matrix vector products by improving the cache hit rate in operations in the form of a sparse matrix called JDS, which is often used in vector computers, as described above.

Specifically, the sparse matrix vector product operation device 100 improves access speed by transforming the sparse matrix to be multiplied to hit the components of the sparse matrix present in the cache memory as much as possible when accessing and computing the components of the multiplying vector. By transforming the sparse matrix to be multiplied, the sparse matrix vector product operation device 100 can improve the speed of operations to obtain the sparse matrix vector products.

The sparse matrix vector product operation device 100 shown in FIG. 1 includes a column rearrangement unit 110 and a matrix vector product operation unit 120.

As shown in FIG. 1, a JDS input matrix is input to the column rearrangement unit 110. The format of the input matrix may be in a format other than JDS (e.g., Compressed Row Storage).

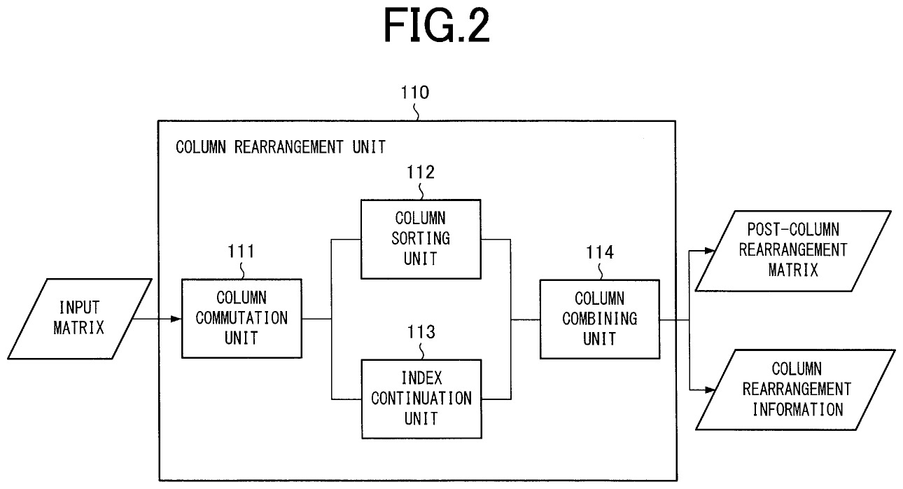

FIG. 2 is a block diagram showing an example of the configuration of a column rearrangement unit 110. The column rearrangement unit 110 shown in FIG. 2 includes a column commutation unit 111, a column sorting unit 112, an Index continuation unit 113, and a column combining unit 114.

In order to hit as many components of the input matrix present in the cache memory as possible in the operation to obtain the sparse matrix vector product, the column rearrangement unit 110 has the function of rearranging the order of each column that constitutes the input matrix.

The column sorting unit 112 of the column rearrangement unit 110 has the function of rearranging each column that constitutes the JDS input matrix in order of the number of non-zero components. In other words, the column sorting unit 112 rearranges each column in order of the number of non-zero components. The columns with the large number of non-zero components in the input matrix are rearranged to the left side of the input matrix by the process of the column sorting unit 112. The column sorting unit 112 may extract the columns with a large number of non-zero components from each column that constitutes the JDS sparse matrix and rearrange the extracted columns in the order of the number of non-zero components.

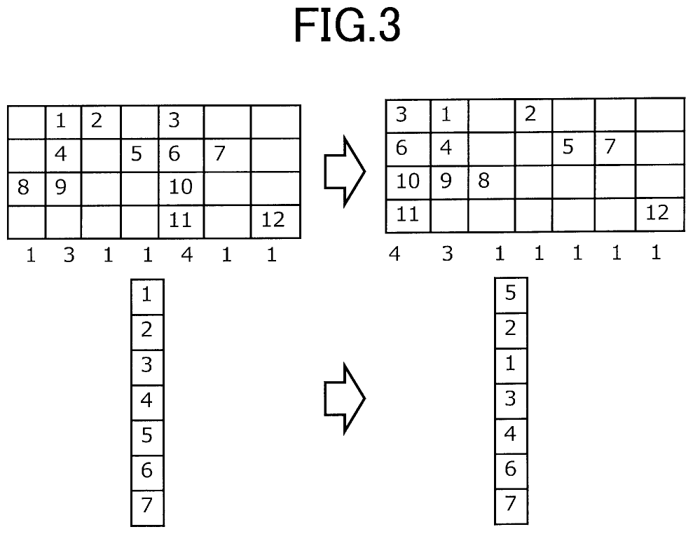

FIG. 3 is an explanatory diagram showing an example of a rearrangement (reposition) of each column that constitutes an input matrix by a column sorting unit 112. The upper left of FIG. 3 shows the input matrix. The lower left of FIG. 3 shows the column vector that is multiplied to the input matrix.

The values shown below the input matrix in FIG. 3 represent the number of occurrences of non-zero components in each column. The column sorting unit 112 rearranges the columns in the order of the frequency of occurrence of the indices, i.e., the number of occurrences of non-zero components per column in the original input matrix.

The upper right of FIG. 3 shows the input matrix whose columns have been rearranged by the column sorting unit 112. As shown in the upper right of FIG. 3, the columns are rearranged in the order of the number of occurrences of non-zero components in the input matrix.

The lower right of FIG. 3 shows the column vector in which each component multiplied with the input matrix has been rearranged. When obtaining the sparse matrix vector product, the column sorting unit 112 generates information that indicates how to rearrange each component of the multiplying column vector corresponding to how the columns of the input matrix are rearranged as “column rearrangement information”.

Referring to FIG. 3, for example, the component “5” in the fifth row of the multiplying column vector is rearranged by the first row. When each component of the multiplying column vector is rearranged in the corresponding rearrangement manner, the sparse matrix vector product obtained from the sparse matrix and column vector before the rearrangement and the sparse matrix vector product obtained from the sparse matrix and column vector after the rearrangement are the same.

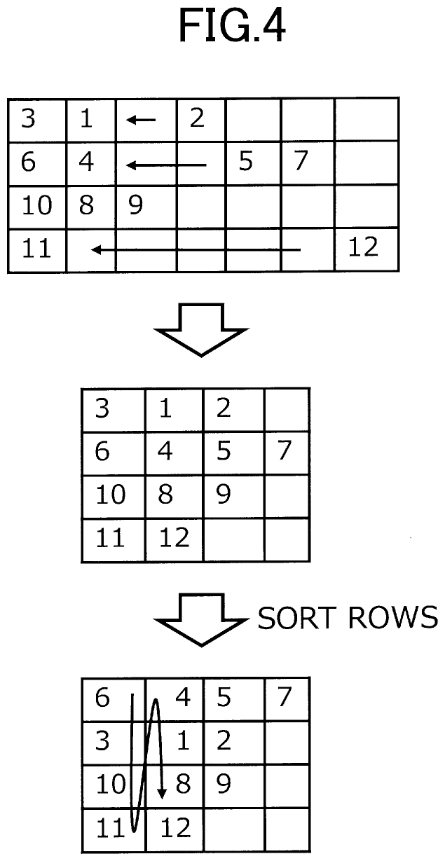

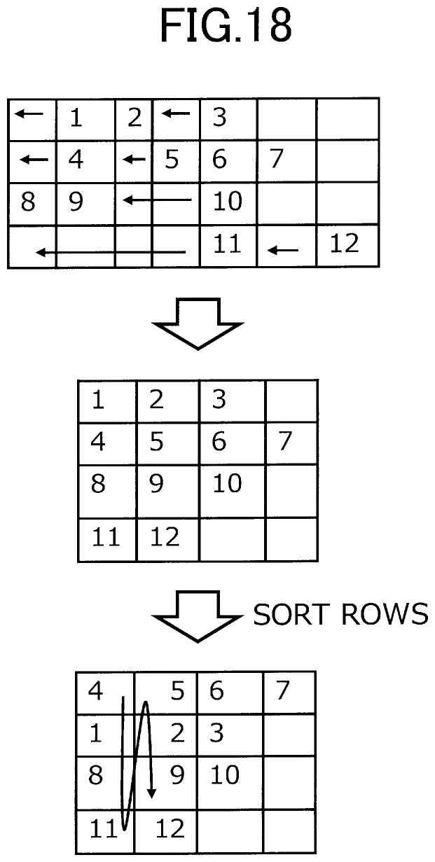

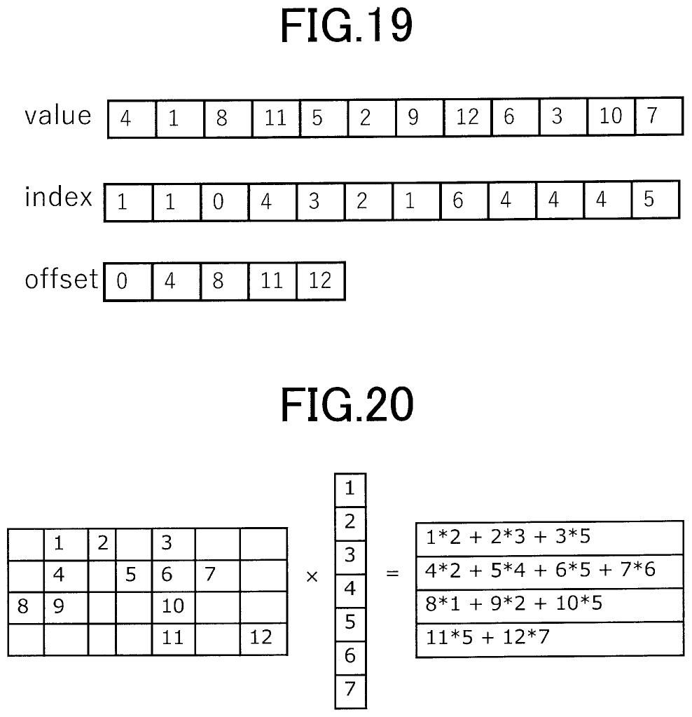

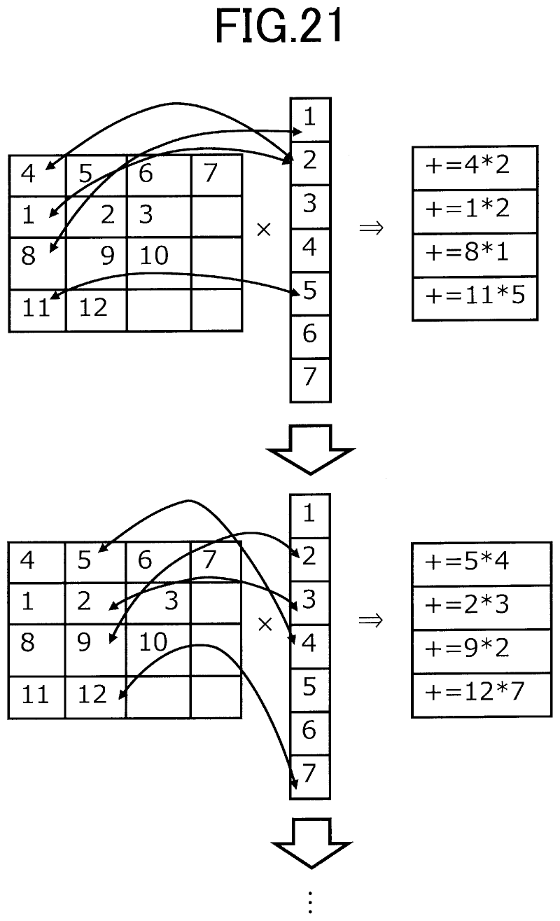

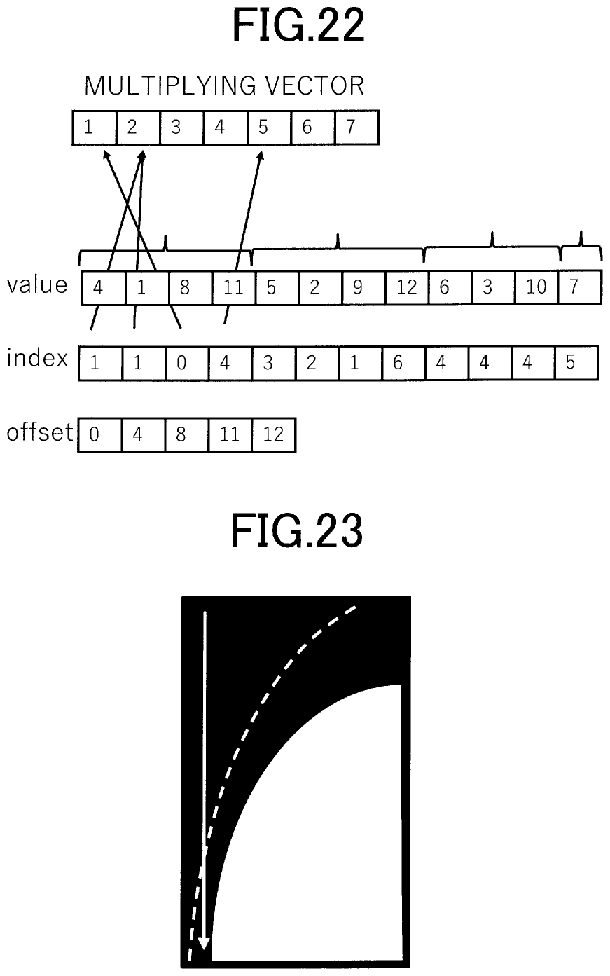

FIG. 4 is an explanatory diagram showing an example of a JDS sparse matrix in this example embodiment. As in FIG. 18, all the non-zero components of the sparse matrix are first packed to the left, as shown in the upper of FIG. 4, and the sparse matrix is transformed to the matrix shown in the middle of FIG. 4. Next, each row of the transformed matrix is sorted in order of the number of non-zero components and transformed to the matrix shown in the lower of FIG. 4. Next, the values of the non-zero components are stored in the column direction (vertical direction) of the transformed matrix.

FIG. 5 is an explanatory diagram showing an example of an internal representation of JDS in this example embodiment. The internal representation of JDS shown in FIG. 5 corresponds to the JDS sparse matrix shown in FIG. 4.

In the index shown in FIG. 5, four consecutive “0”s and three consecutive “1”s are lined up. In other words, when the input matrix is transformed as shown in FIG. 3, the same values tend to line up as the index of each non-zero component of the JDS sparse matrix.

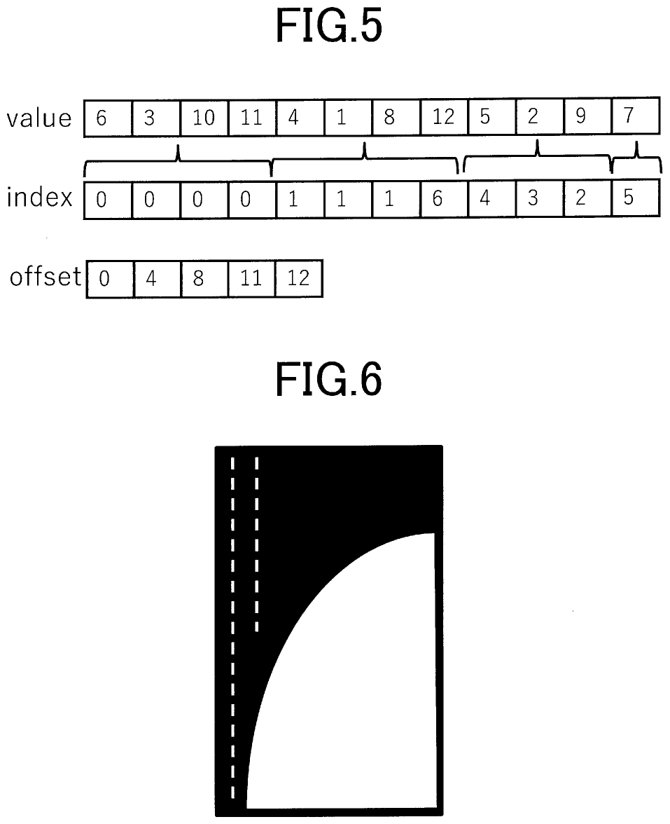

FIG. 6 is a schematic diagram showing a JDS sparse matrix in this example embodiment. As in FIG. 23, the black areas shown in FIG. 6 represent the locations where non-zero components are distributed in the JDS sparse matrix.

The dashed lines shown in FIG. 6 represent the non-zero components with the same index. FIG. 6 shows that the column containing the non-zero components corresponding to the same index that appears most often is located in the first column due to the rearrangement by the column sorting unit 112 shown in FIG. 3.

Unlike FIG. 23, in FIG. 6, the direction of access to the JDS sparse matrix and the direction in which the non-zero components with the same index are lined up are more likely to coincide, so the non-zero components with the same index are more likely to be accessed consecutively.

FIG. 6 also shows that the column containing the non-zero components corresponding to the same index that appears the second most often is located in the second column. Although the direction of access to the JDS sparse matrix and the direction in which the non-zero components with the same index line up may shift after the second column, the non-zero components corresponding to the index that appears the most often are present in the same column comparatively, the cache hit ratio improves, and the performance of the operation to obtain the sparse matrix vector product improves.

The Index continuation unit 113 of the column rearrangement unit 110 has the function of extracting columns with a small number of non-zero components from each column that constitutes the JDS sparse matrix and rearranging the extracted columns so that the indices are as continuous as possible.

The following explains why the Index continuation unit 113 rearranges columns with a small number of non-zero components so that the indices appear consecutively as much as possible. The columns with a small number of non-zero components may not contribute to cache hits, even in JDS.

For example, assuming that the size of cache memory is 1 MB, the upper limit of the size that cache memory can store is 1 MB/8 Byte=256 K using double precision floating point (=8 Byte).

Assuming that the number of rows in the input matrix is 10M, 10M/256K=40, the upper limit of rows that the cache memory can store is 40. Therefore, assuming that non-zero components appear at equal intervals in columns with a small number of non-zero components, if no more than 40 components are present in one column, the column is likely to be kicked out of the cache memory without being reused, even if other non-zero components in the same column are accessed.

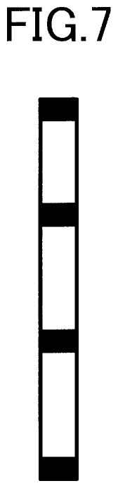

FIG. 7 is an explanatory diagram showing an example of a column with a small number of non-zero components that constitutes a sparse matrix. The black and white rectangles shown in FIG. 7 represent the non-zero and zero components, respectively.

As shown in FIG. 7, even if there are multiple non-zero components in the same column, if other locations are accessed while other non-zero components are accessed, it is likely to be a cache miss and the column will be kicked out of cache memory.

Therefore, for columns with a small number of non-zero components, the Index continuation unit 113 rearranges the columns so that the indices appear as consecutive as possible, considering that adjacent columns in the original input matrix tend to be the same column in JDS.

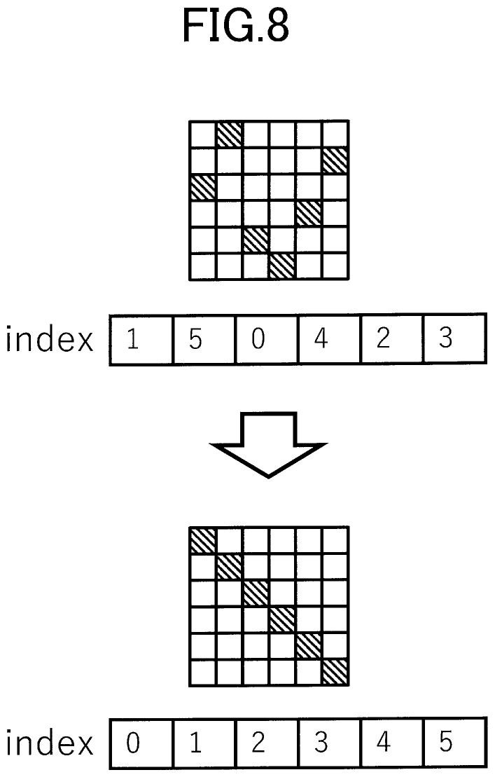

FIG. 8 is an explanatory diagram showing an example of a rearrangement of each column that constitutes an input matrix by an Index continuation unit 113. For the sake of simplicity, we consider a sparse matrix with only one non-zero component in each row and column shown in FIG. 8 in explaining how to rearrange columns by the Index continuation unit 113. The sparse matrix with only one non-zero component in each row and column is transformed to a single-column vector in JDS.

In the sparse matrix shown in the upper of FIG. 8, the non-zero components are randomly distributed, so the ordering of the indices in JDS is also random, and a cache miss is likely to occur for the above reasons.

As shown in the lower of FIG. 8, the Index continuation unit 113 rearranges the columns so that the indices line up consecutively. Since the indices line up consecutively, the cache hit ratio is improved.

The reason for the improved cache hit ratio is that values stored in cache memory are managed in a range containing multiple values, called a “cache line”. In the example shown in FIG. 8, if a non-zero component of the column of index “0” is loaded into cache memory due to a cache miss, the non-zero components of the adjacent columns of index “1,” “2,” etc., which are present in the same cache line, will be loaded into cache memory at the same timing.

This is because, as mentioned above, in JDS, adjacent columns in the original input matrix tend to be the same column, and the cache hit ratio is improved by loading the non-zero components of each column into the cache memory together.

Similar to the column sorting unit 112, the Index continuation unit 113 generates information that indicates how to rearrange each component of the multiplying column vector corresponding to how to rearrange the columns of the input matrix as “column rearrangement information”. When each component of the multiplying column vector is rearranged in the corresponding to how to rearrange, the sparse matrix vector product obtained with the sparse matrix and the column vector before the rearrangement and the sparse matrix vector product obtained with the sparse matrix and the column vector after the rearrangement are the same.

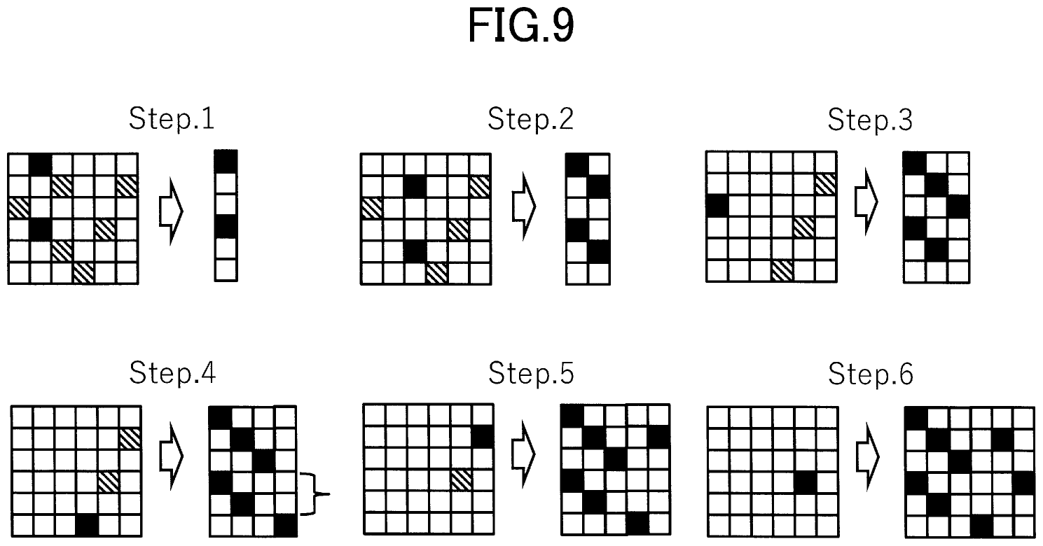

FIG. 9 is an explanatory diagram showing an example of another rearrangement of each column that constitutes an input matrix by an Index continuation unit 113. The left matrix in each Step shown in FIG. 9 represents the input matrix. The black rectangle in the input matrix shown in FIG. 9 represents the non-zero component in the extracted column described below.

For the sake of simplicity, columns with many non-zero components are omitted in the input matrix shown in FIG. 9. In addition, since the order of rows is rearranged in JDS, FIG. 9 shows the matrix after the rows are rearranged. In addition, the right matrix in each Step shown in FIG. 9 represents the matrix in which each column that constitutes the input matrix has been rearranged.

The Index continuation unit 113 performs the following specific operations on the input matrix. First, the Index continuation unit 113 searches for non-zero components from the top-most row in the row direction. Once the non-zero components are searched, the Index continuation unit 113 extracts from the input matrix the column containing the searched non-zero components. Next, the Index continuation unit 113 adds the first extracted column as the first column to the matrix in which each column is rearranged (Step. 1).

Next, the Index continuation unit 113 performs the same process for the second row from the top, and adds the second extracted column as the second column to the matrix in which each column is rearranged (Step. 2). Next, the Index continuation unit 113 performs the same process for the third row from the top, and adds the third extracted column as the third column to the matrix in which each column is rearranged (Step. 3).

Since there are already non-zero components in the fourth and fifth rows from the top of the matrix in which each column is rearranged (at the parentheses in Step. 4), the Index continuation unit 113 skips the fourth and fifth rows from the top and moves to the next row. Next, the Index continuation unit 113 performs the same process for the sixth row from the top and adds the fourth extracted column as the fourth column to the matrix where each column is rearranged (Step. 4).

Row skipping occurs when there are multiple non-zero components in one extracted column or when the extraction of the previous column is repeated. Note that skipped rows are rows that have not yet been kicked out of cache memory and are expected to have a high likelihood of cache hits because nearby columns have been accessed.

After completing process for the bottom-most row, the Index continuation unit 113 repeats the same process starting with the top-most row. Note that the Index continuation unit 113 skips rows that have no non-zero components.

For example, the top-most row already has no non-zero components, so the Index continuation unit 113 skips the top-most row. Since the second row from the top has a non-zero component, the Index continuation unit 113 performs the same process for the second row from the top and adds the fifth extracted column as the fifth column to the matrix where each column is rearranged (Step. 5).

Since the third row from the top already has no non-zero components, the Index continuation unit 113 skips the third row from the top. Since the fourth row from the top has a non-zero component, the Index continuation unit 113 performs the same process for the fourth row from the top and adds the sixth extracted column as the sixth column to the matrix where each column is rearranged (Step. 6). After all non-zero components have been extracted from the input matrix, the Index continuation unit 113 completes the rearrangement of each column.

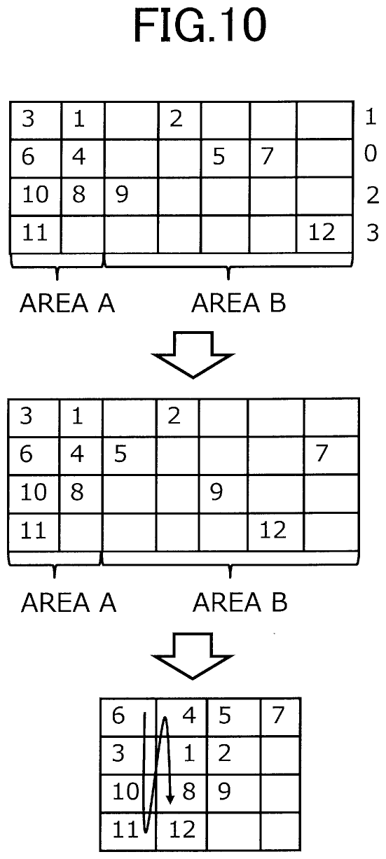

FIG. 10 is an explanatory diagram showing another example of a JDS sparse matrix in this example embodiment. The sparse matrix shown in the upper of FIG. 10 is the input matrix whose columns have been rearranged by the column sorting unit 112. The numbers to the right of the sparse matrix are the order of the rows after they have been sorted in JDS.

A matrix with less than a predetermined number of non-zero components in columns (the matrix in area B shown in the upper of FIG. 10) is input to the Index continuation unit 113. The Index continuation unit 113 searches for non-zero components in the row direction, starting with the top-most row in JDS.

Next, the Index continuation unit 113 extracts the columns that contain the searched non-zero components. The Index continuation unit 113 then adds the first extracted column as the first column to the matrix with each column rearranged in area B. By repeating the above process for each row, the Index continuation unit 113 generates the matrix in area B shown in the middle of FIG. 10.

Next, each row of the transformed matrix is sorted in order of the number of non-zero components to transform it into the matrix shown in the lower of FIG. 10. Next, the values of the non-zero components are stored in the column direction (vertical direction) of the transformed matrix.

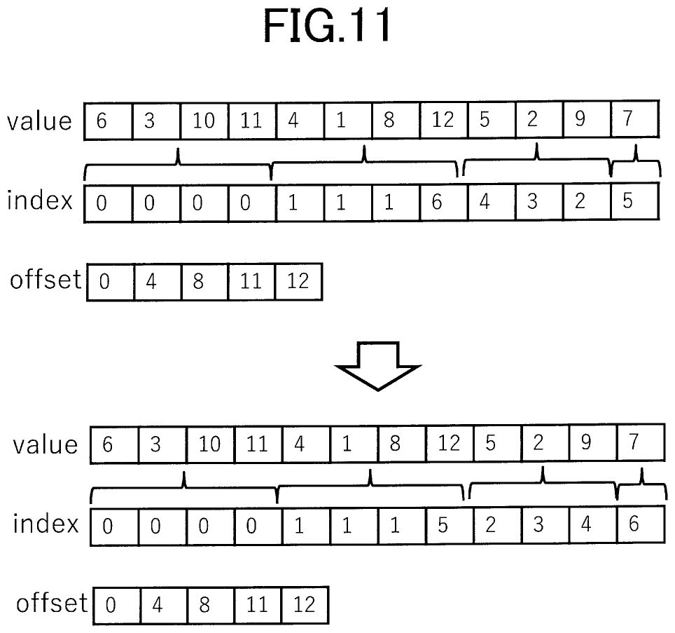

FIG. 11 is an explanatory diagram showing another example of an internal representation of JDS in this example embodiment. The internal representation of JDS shown in the upper of FIG. 11 corresponds to the JDS sparse matrix shown in FIG. 4. The internal representation of JDS shown in the lower of FIG. 11 corresponds to the JDS sparse matrix shown in FIG. 10. The internal representation shown in the upper of FIG. 11 is transformed to the internal representation shown in the lower of FIG. 11 by the process of the Index continuation unit 113.

In the index shown in the lower of FIG. 11, “2”, “3”, and “4” line up in one column consecutively. Therefore, when the JDS sparse matrix shown in FIG. 10 is used, if a non-zero component of the column of index “2” is loaded into cache memory due to a cache miss, the non-zero components of the adjacent columns of indices “3” and “4” in the same cache line are loaded into the cache memory at the same timing. Therefore, since each non-zero component is present in the same column of the JDS sparse matrix, the cache hit rate is improved, and thus the performance of the operation to obtain the sparse matrix vector product is improved.

The column commutation unit 111 has the function of dividing the input matrix based on the number of non-zero components per column. In the example shown in FIG. 10, the column commutation unit 111 divides the input matrix into a matrix in area A (a matrix in which the number of non-zero components in a column is greater than a predetermined value) and a matrix in area B (a matrix in which the number of non-zero components in a column is less than a predetermined value). The column commutation unit 111 then inputs the matrix in area A to the column sorting unit 112 and the matrix in area B to the Index continuation unit 113, respectively.

The column combining unit 114 has the function of generating a new matrix by combining the matrices whose columns have been rearranged. In the example shown in FIG. 10, the column combining unit 114 receives the matrix in area A with rearranged columns from the column sorting unit 112 and the matrix in area B with rearranged columns from the Index continuation unit 113, respectively.

Next, the column combining unit 114 combines the matrices whose columns have been rearranged to generate a new matrix. In the example shown in FIG. 10, the column combining unit 114 generates the matrix shown in the middle of FIG. 10. Specifically, the column combining unit 114 combines the matrix in the area A where the columns have been rearranged and the matrix in the area B where the columns have been rearranged, in the order of the matrix in the area A where the columns have been rearranged and the matrix in the area B where the columns have been rearranged, in the horizontal direction.

The new matrix generated by the column combining unit 114 corresponds to the post-column rearrangement matrix shown in FIGS. 1-2. The column rearrangement information is input to the column combining unit 114 from the column sorting unit 112 and the Index continuation unit 113, respectively. The column combining unit 114 then inputs the post-column rearrangement matrix and the column rearrangement information to the matrix vector product operation unit 120.

The matrix vector product operation unit 120 has the function of performing the operation to obtain the sparse matrix vector product for the post-column rearrangement matrix. An input vector, which is a vector to be multiplied to the post-column rearrangement matrix, is input to the matrix vector product operation unit 120.

The matrix vector product operation unit 120 uses the column rearrangement information to rearrange each component of the input vector. Next, the matrix vector product operation unit 120 computes the multiplication of the post-column rearrangement matrix with the input vector whose components have been rearranged. By computing the multiplication, the matrix vector product operation unit 120 obtains the sparse matrix vector product.

The post-column rearrangement matrix and column rearrangement information may be reused after being stored in memory, etc.

As described above, the column sorting unit 112 of this example embodiment generates a second sparse matrix of a predetermined form (the matrix in area A shown in the upper of FIG. 10) by arranging the plurality of columns having a predetermined number or more non-zero components among the plurality of columns constituting a first sparse matrix of the predetermined form (input matrix) in order of the number of non-zero components.

The Index continuation unit 113 of this example embodiment also performs an addition process of searching in the row direction for a non-zero component of the row constituting the work matrix (the matrix in area B shown in the upper of FIG. 10), which is composed of a plurality of columns having less than a predetermined number of non-zero components among a plurality of columns constituting the first sparse matrix, and when the non-zero component is searched, extracting the column with the non-zero component constituting the work matrix from the work matrix, and adding the k-th extracted column to the third sparse matrix of the predetermined form (the matrix in area B shown in the middle of FIG. 10) as the k-th column, for each row constituting the work matrix, in order from top repeatedly.

If there are still non-zero components in the work matrix after performing the addition process for the bottom row, the Index continuation unit 113 of this example embodiment may perform the addition process again for each row constituting the work matrix, in order from top repeatedly.

The column combining unit 114 of this example embodiment also generates a fourth sparse matrix of the predetermined form (post-column rearrangement matrix) by combining the second sparse matrix and the third sparse matrix in which all the addition processes have been performed, in the order of the second sparse matrix and the third sparse matrix in the horizontal direction.

The matrix vector product operation unit 120 of this example embodiment also rearranges each component of the vector that is the object of multiplication with the first sparse matrix according to the order in which each column constituting the first sparse matrix is rearranged in the fourth sparse matrix. The matrix vector product operation unit 120 also computes the multiplication of the fourth sparse matrix with the vector whose each component has been rearranged.

The column rearrangement unit 110 of this example embodiment may include only one of the column sorting unit 112 and the Index continuation unit 113.

[Description of Operation]

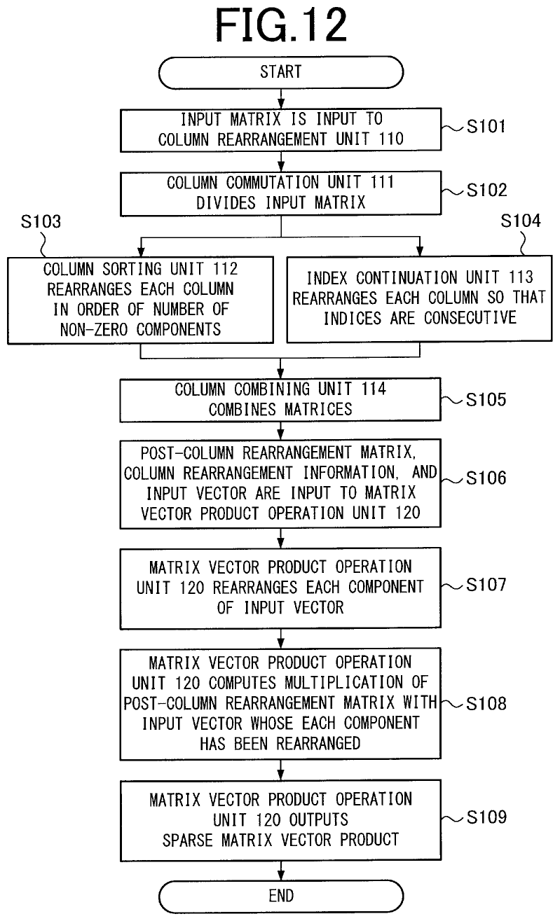

The operation for obtaining a sparse matrix vector product of the sparse matrix vector product operation device 100 of this example embodiment will be described below with reference to FIG. 12. FIG. 12 is a flowchart showing the operation of the sparse matrix vector product operation processing by the sparse matrix vector product operation device 100 of this example embodiment.

First, the input matrix, which is the JDS sparse matrix, is input to the column rearrangement unit 110 of the sparse matrix vector product operation device 100 (step S101).

Next, the column commutation unit 111 of the column rearrangement unit 110 divides the input matrix into a matrix in which the number of non-zero components in a column is greater than a predetermined value and a matrix in which the number of non-zero components in a column is less than a predetermined value (step S102). The column commutation unit 111 then inputs the matrix with the number of non-zero components of a column greater than a predetermined value to the column sorting unit 112 and the matrix with the number of non-zero components of a column less than a predetermined value to the Index continuation unit 113, respectively.

Next, the column sorting unit 112 rearranges each column that constitutes a matrix in which the number of non-zero components in a column is greater than a predetermined value, in order of the number of non-zero components (step S103). The column sorting unit 112 also generates the column rearrangement information based on the rearranged columns. The column sorting unit 112 then inputs the matrix with the rearranged columns and the column rearrangement information to the column combining unit 114.

The Index continuation unit 113 also rearranges each column constituting a matrix in which the number of non-zero components in a column is less than a predetermined value so that the indices are consecutive as much as possible (step S104). The Index continuation unit 113 also generates column rearrangement information based on the rearranged columns. The Index continuation unit 113 then inputs the matrix with the rearranged columns and the column rearrangement information to the column combining unit 114.

Next, the column combining unit 114 combines the input matrices with the rearranged columns (step S105). Next, the column combining unit 114 inputs the post-column rearrangement matrix generated by the combining and the column rearrangement information to the matrix vector product operation unit 120. The input vector, which is the vector to be multiplied to the post-column rearrangement matrix, is also input to the matrix vector product operation unit 120 (step S106).

Next, the matrix vector product operation unit 120 uses the input column rearrangement information to rearrange each component of the input vector (step S107). Next, the matrix vector product operation unit 120 computes the multiplication of the post-column rearrangement matrix with the input vector whose each component has been rearranged (step S108).

By computing the multiplication, the matrix vector product operation unit 120 obtains the sparse matrix vector product. Next, the matrix vector product operation unit 120 outputs the obtained sparse matrix vector product (step S109). After outputting, the sparse matrix vector product operation device 100 terminates the sparse matrix vector product operation processing.

[Description of Effects]

The column sorting unit 112 of this example embodiment rearranges the columns in the order of the number of non-zero components for the columns with the large number of non-zero components among each column constituting the sparse matrix. By rearranging, the direction of access to the JDS sparse matrix and the direction in which the non-zero components with the same index are lined up are more likely to coincide, thus increasing the likelihood that the non-zero components with the same index will be accessed consecutively.

In addition, the Index continuation unit 113 of this example embodiment rearranges the columns so that the indices are consecutive as much as possible for the columns with the small number of non-zero components among each column constituting the sparse matrix. By rearranging, if a non-zero component of any column of consecutive indices is loaded into cache memory due to a cache miss, the non-zero components of other adjacent columns of indices in the same cache line are loaded into cache memory at the same timing.

Since any of the above processes improves the cache hit rate in the operation to obtain the sparse matrix vector product, the sparse matrix vector product operation device 100 of this example embodiment can improve the performance of the operation to obtain the sparse matrix vector product.

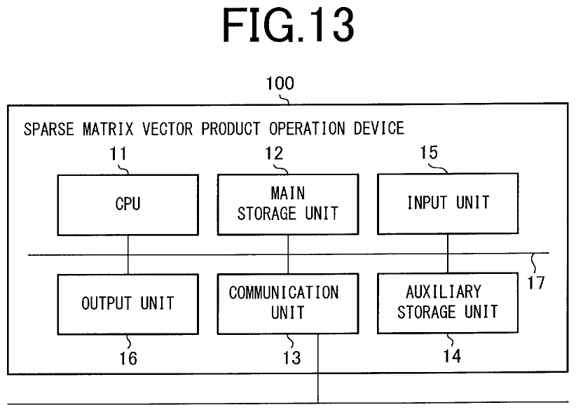

A specific example of a hardware configuration of the sparse matrix vector product operation device 100 according to this example embodiment will be described below. FIG. 13 is an explanatory diagram showing an example of a hardware configuration of the sparse matrix vector product operation device 100 according to the present invention.

The sparse matrix vector product operation device 100 shown in FIG. 13 includes a CPU (Central Processing Unit) 11, a main storage unit 12, a communication unit 13, and an auxiliary storage unit 14. The sparse matrix vector product operation device 100 also includes an input unit 15 for the user to operate and an output unit 16 for presenting a processing result or a progress of the processing contents to the user.

The sparse matrix vector product operation device 100 is realized by software, with the CPU 11 shown in FIG. 13 executing a program that provides a function that each component has.

Specifically, each function is realized by software as the CPU 11 loads the program stored in the auxiliary storage unit 14 into the main storage unit 12 and executes it to control the operation of the sparse matrix vector product operation device 100.

The sparse matrix vector product operation device 100 shown in FIG. 13 may include a DSP (Digital Signal Processor) instead of the CPU 11. Alternatively, the sparse matrix vector product operation device 100 shown in FIG. 13 may include both the CPU 11 and the DSP.

The main storage unit 12 is used as a work area for data and a temporary save area for data. The main storage unit 12 is, for example, RAM (Random Access Memory).

The communication unit 13 has a function of inputting and outputting data to and from peripheral devices through a wired network or a wireless network (information communication network).

The auxiliary storage unit 14 is a non-transitory tangible medium. Examples of non-transitory tangible media are, for example, a magnetic disk, an optical magnetic disk, a CD-ROM (Compact Disk Read Only Memory), a DVD-ROM (Digital Versatile Disk Read Only Memory), a semiconductor memory.

The input unit 15 has a function of inputting data and processing instructions. The input unit 15 is, for example, an input device such as a keyboard, a mouse, or a touch panel.

The output unit 16 has a function to output data. The output unit 16 is, for example, a display device such as a liquid crystal display device, a touch panel, or a printing device such as a printer.

As shown in FIG. 13, in the sparse matrix vector product operation device 100, each component is connected to the system bus 17.

The auxiliary storage unit 14 stores programs for realizing the column rearrangement unit 110 and the matrix vector product operation unit 120 in the sparse matrix vector product operation device 100.

The sparse matrix vector product operation device 100 may be implemented with a circuit that contains hardware components inside such as an LSI (Large Scale Integration) that realize the functions shown in FIG. 1, for example.

The sparse matrix vector product operation device 100 may be realized by hardware that does not include computer functions using elements such as a CPU. For example, some or all of the components may be realized by a general-purpose circuit (circuitry) or a dedicated circuit, a processor, or a combination of these. They may be configured by a single chip (for example, the LSI described above) or by multiple chips connected via a bus. Some or all of the components may be realized by a combination of the above-mentioned circuit, etc. and a program.

Some or all of each component of the sparse matrix vector product operation device 100 may be configured by one or more information processing devices which include a computation unit and a storage unit.

In the case where some or all of the components are realized by a plurality of information processing devices, circuits, or the like, the plurality of information processing devices, circuits, or the like may be centrally located or distributed. For example, the information processing devices, circuits, etc. may be realized as a client-server system, a cloud computing system, etc., each of which is connected via a communication network.

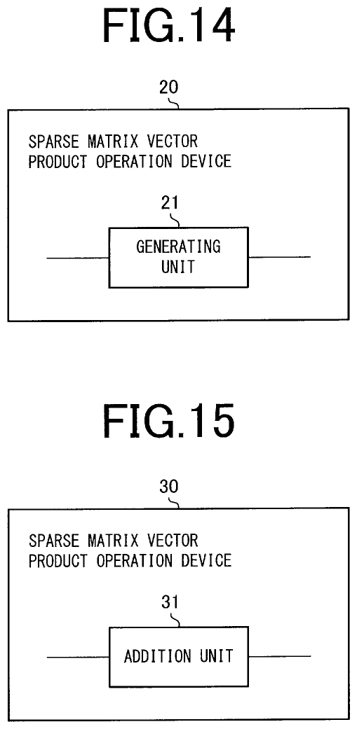

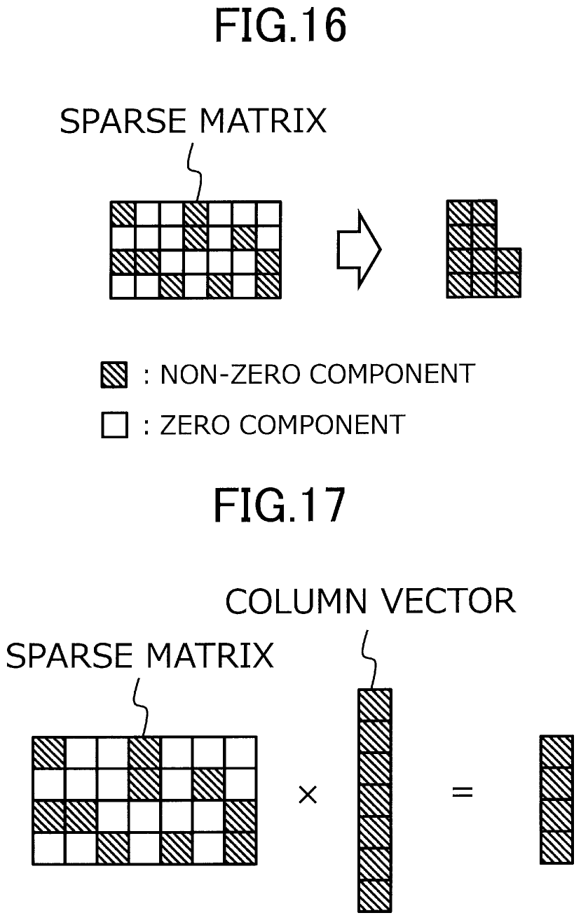

Next, an overview of the present invention will be explained. FIG. 14 is a block diagram showing an overview of a sparse matrix vector product operation device according to the present invention. The sparse matrix vector product operation device 20 according to the present invention includes a generating unit 21 (for example, the column sorting unit 112) which generates a second sparse matrix of a predetermined form by arranging a plurality of columns having a predetermined number or more non-zero components among a plurality of columns constituting a first sparse matrix of the predetermined form in order of the number of non-zero components.

The sparse matrix vector product operation device 20 may also include an addition unit (for example, the Index continuation unit 113) which performs an addition process of searching in a row direction for a non-zero component of a row constituting a work matrix, which is composed of a plurality of columns having less than a predetermined number of non-zero components among a plurality of columns constituting the first sparse matrix, and when the non-zero component is searched, extracting a column with the non-zero component constituting the work matrix from the work matrix, and adding the k-th extracted column to a third sparse matrix of the predetermined form as the k-th column, for each row constituting the work matrix, in order from top repeatedly.

If there are still non-zero components in the work matrix after performing the addition process for the bottom row, the addition unit may also perform the addition process again for each row constituting the work matrix, in order from top repeatedly.

With such a configuration, the sparse matrix vector product operation device can improve the performance of operations to obtain sparse matrix vector products.

The sparse matrix vector product operation device 20 may also include a combining unit (for example, the column combining unit 114) which generates a fourth sparse matrix of the predetermined form by combining the second sparse matrix and the third sparse matrix in which all the addition processes have been performed, in the order of the second sparse matrix and the third sparse matrix in a horizontal direction.

The sparse matrix vector product operation device 20 may also include a rearrangement unit (for example, the matrix vector product operation unit 120) which rearranges each component of a vector that is an object of multiplication with the first sparse matrix according to the order in which each column constituting the first sparse matrix is rearranged in the fourth sparse matrix.

With such a configuration, the sparse matrix vector product operation device can obtain the correct sparse matrix vector products.

The sparse matrix vector product operation device 20 may also include an operation unit (for example, the matrix vector product operation unit 120) which computes the multiplication of the fourth sparse matrix with the vector whose each component has been rearranged. The predetermined form may also be Jagged Diagonal Storage.

FIG. 15 is a block diagram showing another overview of a sparse matrix vector product operation device according to the present invention. The sparse matrix vector product operation device 30 according to the present invention includes an addition unit 31 (for example, the Index continuation unit 113) which performs an addition process of searching in a row direction for a non-zero component of a row constituting a work matrix, which is composed of a plurality of columns having less than a predetermined number of non-zero components among a plurality of columns constituting a first sparse matrix of a predetermined form, and when the non-zero component is searched, extracting a column with the non-zero component constituting the work matrix from the work matrix, and adding the k-th extracted column to a second sparse matrix of the predetermined form as the k-th column, for each row constituting the work matrix, in order from top repeatedly.

If there are still non-zero components in the work matrix after performing the addition process for the bottom row, the addition unit 31 may also perform the addition process again for each row constituting the work matrix, in order from top repeatedly.

With such a configuration, the sparse matrix vector product operation device can improve the performance of operations to obtain sparse matrix vector products.

The sparse matrix vector product operation device 30 may also include a rearrangement unit (for example, the matrix vector product operation unit 120) which rearranges each component of a vector that is an object of multiplication with the first sparse matrix according to the order in which each column constituting the first sparse matrix is rearranged in the second sparse matrix in which all the addition processes have been performed.

With such a configuration, the sparse matrix vector product operation device can obtain the correct sparse matrix vector products.

The sparse matrix vector product operation device 30 may also include an operation unit (for example, the matrix vector product operation unit 120) which computes the multiplication of the second sparse matrix with the vector whose each component has been rearranged. The predetermined form may also be Jagged Diagonal Storage.

The multiplication of a sparse matrix with a column vector using a JDS sparse matrix has the following issues. Access to the matrix stored in memory and to the sparse matrix vector product, which is the vector of multiplication results, is fast because the components to be accessed are continuous.

However, access to the multiplying vector is often slow because the components to be accessed are randomized according to the value of index. Because access to the multiplying vector tends to be slow, the multiplication of the sparse matrix with the column vector using the JDS sparse matrix is also often slow.

For example, suppose that columns containing non-zero components in many rows are present in a sparse matrix. Especially in machine learning, columns containing non-zero components are often biased, so the above columns may occur in the sparse matrix.

In a JDS sparse matrix, the index values of the non-zero components in the columns as described above will be the same. Therefore, when the non-zero components are accessed consecutively, the columns which are present in the cache memory are reused, and thus the opportunities for cache hits are likely to occur. However, in the JDS sparse matrix, the non-zero components in the columns as described above are not present in the same column, so opportunities for cache hits are less likely to occur.

FIG. 23 is a schematic diagram showing a JDS sparse matrix. The black areas shown in FIG. 23 represent the locations where non-zero components are distributed in the JDS sparse matrix.

The dashed line shown in FIG. 23 represent non-zero components with the same index. As shown in FIG. 23, the non-zero components with the same index are in different columns in the JDS sparse matrix. Since the non-zero components are left-justified in the JDS sparse matrix, the non-zero components that are in the same column in the original sparse matrix are in different columns.

The solid arrow shown in FIG. 23 represent the access direction to the JDS sparse matrix. Since the JDS sparse matrix is accessed in the column direction, non-zero components with the same index are not accessed continuously, and the operation to obtain the sparse matrix vector product is often slow. Also, International Publication No. WO 2017/154946, Japanese Patent Application Laid-Open No. 2019-175040, and International Publication No. WO 2021/024300 do not describe any technique that can solve the problem of slow operations to obtain the sparse matrix vector product due to the above reasons.

According to this invention, it is possible to improve the performance of operations to obtain sparse matrix vector products.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

What is claimed is:

1. A sparse matrix vector product operation device comprising:
a memory configured to store instructions; and
a processor configured to execute the instructions to:
generate a second sparse matrix of a predetermined form by arranging a plurality of columns having a predetermined number or more non-zero components among a plurality of columns constituting a first sparse matrix of the predetermined form in order of the number of non-zero components.

2. The sparse matrix vector product operation device according to claim 1, wherein the processor is further configured to execute the instructions to:
perform an addition process of searching in a row direction for a non-zero component of a row constituting a work matrix, which is composed of a plurality of columns having less than a predetermined number of non-zero components among a plurality of columns constituting the first sparse matrix, and when the non-zero component is searched, extracting a column with the non-zero component constituting the work matrix from the work matrix, and adding the k-th (k is a positive integer) extracted column to a third sparse matrix of the predetermined form as the k-th column, for each row constituting the work matrix, in order from top repeatedly.

3. The sparse matrix vector product operation device according to claim 2, wherein the processor is further configured to execute the instructions to:
generate a fourth sparse matrix of the predetermined form by combining the second sparse matrix and the third sparse matrix in which all the addition processes have been performed, in the order of the second sparse matrix and the third sparse matrix in a horizontal direction.

4. The sparse matrix vector product operation device according to claim 3, wherein the processor is further configured to execute the instructions to:
rearrange each component of a vector that is an object of multiplication with the first sparse matrix according to the order in which each column constituting the first sparse matrix is rearranged in the fourth sparse matrix.

5. The sparse matrix vector product operation device according to claim 4, wherein the processor is further configured to execute the instructions to:
compute the multiplication of the fourth sparse matrix with the vector whose each component has been rearranged.

6. A sparse matrix vector product operation device comprising:
a memory configured to store instructions; and
a processor configured to execute the instructions to:
perform an addition process of searching in a row direction for a non-zero component of a row constituting a work matrix, which is composed of a plurality of columns having less than a predetermined number of non-zero components among a plurality of columns constituting a first sparse matrix of a predetermined form, and when the non-zero component is searched, extracting a column with the non-zero component constituting the work matrix from the work matrix, and adding the k-th extracted column to a second sparse matrix of the predetermined form as the k-th column, for each row constituting the work matrix, in order from top repeatedly.

7. A sparse matrix vector product operation method comprising:
generating a second sparse matrix of a predetermined form by arranging a plurality of columns having a predetermined number or more non-zero components among a plurality of columns constituting a first sparse matrix of the predetermined form in order of the number of non-zero components.
